(19) United States
(12) Patent Application Publication
(10) Pub. No.: US 2007/0204738 A1
(43) Pub. Date: Sep. 6, 2007

(54) Perforation over perforation die cutter and method of manufacture

(76) Inventor: Andrew P. Frey, Cincinnati, OH (US)

Correspondence Address: SEED INTELLECTUAL PROPERTY LAW GROUP PLLC, 701 FIFTH AVENUE, SUITE 5400, SEATTLE, WA, 98104-7092, US

(21) Appl. No.: 11/367,032

(22) Filed: Mar. 1, 2006

(51) Int. Cl. B26D 1/12

(52) U.S. Cl. 83/663; 83/669

(57) ABSTRACT

A perforation over perforation die with a multi-level blade on an engraved rotary tool, on thin plate tooling applied to a magnetic cylinder or on a removable perforation blade die. The single die has a multi-level blade that creates dual cuts in the face sheet and liner of the label. The blade comprises a plurality of cutting projections separated by a plurality of depressions; a plurality of first depressions have a first height and a cutting surface at their base and a plurality of second depressions have a second height. The first and second depressions are interspersed at regular intervals.

This application claims the benefit of U.S. Provisional Application No. 6/657877 filed 1 Mar. 2005 entitled Perforation over Perforation Die Cutter and Method of Manufacture.

### BACKGROUND OF THE INVENTION

1. Field Of The Invention

The present invention relates to cutting of labels. More specifically, a relates to a method of placing a perforation on the label with one set of specifications and a second perforation with a different set of specifications through the liner.

2. Description of Related Art

Perforation over perforation die cutting is when the label is perforated based on one set of specifications for the face sheet a second set of specifications for the liner. Perforation over perforation die cutting is useful where the perforations have separate specifications such as one requires weak separation and the other one sturdier seperation.

Prior art methods of perforation over perforation die cutting with traditional tooling require the use of two separate die cutters. The disadvantage of using two die cutters is that it is virtually impossible to maintain perfect registration between the two perforations. Further, when using a two die set up and one perforation is place directly on top of the other, there is not enough substrate in the liner to support the face sheet for cutting.

There is a need for a perforation over perforation die which allows perforation over perforation die cutting with a single die.

There is a prior art method of of cutting referred to as slit over perforation. Slit over perforation uses a single die to slit or cut through the face completely and cut a perforation in the liner or perforate the face sheet and slit the liner. The use of a single die results in labels with a perfectly aligned the slit over the perforation. The alignment is ensured since all cutting is done by a single die cutting from the face side or the liner side of the material. Extreme precision in die heights is mandatory since both the absolute heights as well as the difference is critical.

### SUMMARY OF THE INVENTION

The present invention is a perforation over perforation die. Preferrably, the multi-level blade is on an engraved rotary tool, on thin plate tooling applied to a magnetic cylinder or on a removable perforation blade die. The single die has a multi-level blade that creates dual cuts in the face sheet and liner of the label. The blade comprises a plurality of cutting projections separated by a plurality of depressions. A plurality of first depressions have a first height and a cutting surface at their base and a plurality of second depressions have a second height. The first and second depressions are interspersed at regular intervals.

When the die cutter is arranged such that the die cuts from the face sheet side of the label, the cutting projections cut through the face sheet and the liner, the cutting surface of the first depressions cut through the face sheet only leaving ties in the liner and the second depressions leave ties in both the face sheet and the liner.

The cutting projections and the cutting surfaces of the first depressions preferably cut metal on metal, i.e. the metal of the blade cuts against a metal surface.

The perforations can be any cut/tie combination. Preferably, the blade is hand sharpened. When the blade is hand sharpened, the liner perforations are preferably at least 0.027 inches in the tie area.

### BRIEF DESCRIPTION OF THE FIGURES

FIG. 1 is a cross-section of a die.

FIG. 2 is an expanded cross-sectional view of the surface of the die.

FIG. 3 is a cross section of a perforation over perforation label.

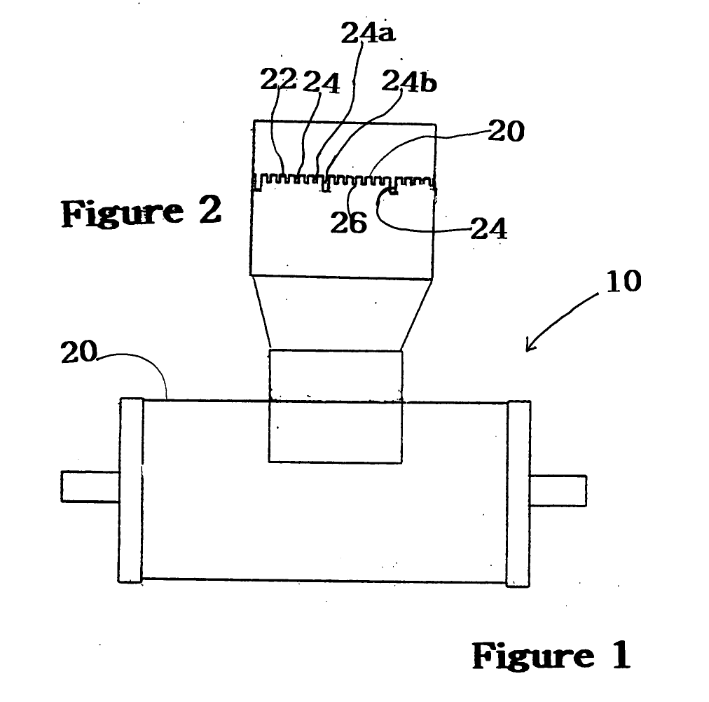

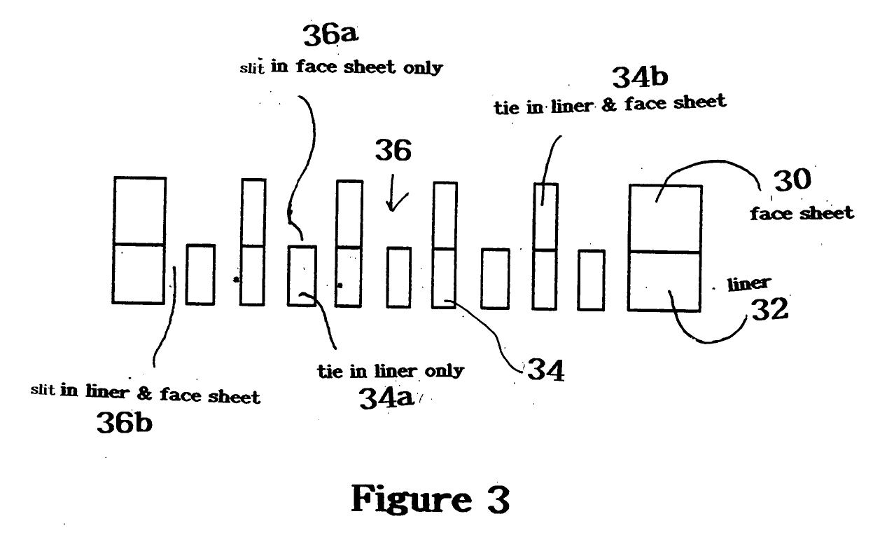

### DETAILED DESCRIPTION OF THE INVENTION

The present invention is a perforation over perforation die 10. Preferably, the multi-level blade 20 is on an engraved rotary tool, on thin plate tooling applied to a magnetic cylinder or on a removable perforation blade die. Single die 10 has a multi-level blade 20 that creates dual cuts in face sheet 30 and liner 32 of label. Blade 20 comprises a plurality of cutting projections 22 separated by a plurality of depressions 24. A plurality of first depressions 24a each having a first height and a cutting surface at their base 26 and a plurality of second depressions 24b each having a second height. The first and second depressions 24 are interspersed at regular intervals.

Projections 22 cut slits 36b through both liner 32 and label face sheet 30. Cutting surface 26 of first depressions 24a cut slits 36a in one of liner 32 or label face sheet 30 leaving ties 34a in the other. Second depressions do not cut and thus leave ties 34b in both liner 32 and label face sheet 30.

As shown in FIG. 2, when die 10 is arranged relative to the label such that die 10 cuts from face sheet 30 side of label, cutting projections 22 cut slits 36 through face sheet 30 and liner 32. Cutting surfaces 26 of first depressions 24a cut slits 36 through face sheet 30 only leaving ties 34 in liner 32. Second depressions 24 does not cut through either face sheet 30 or liner 32, thus leaving ties 34 in both face sheet 30 and liner 32.

When die 10 is arranged relative to the label such that the die 10 cuts from the liner 32 side of the label, cutting projections 22 cut slits 36 through liner 32 and face sheet 30. Cutting surfaces 26 of first depressions 24a cut slits 36 through liner 32 only, leaving ties 34 in face sheet 30. Second depressions 24b do not cut through either liner 32 or face sheet 30 and thus leaves ties 34 in both liner 32 and face sheet 30.

Cutting projections 22 and cutting surfaces 26 of first depressions 24a preferably cut metal on metal, i.e. the metal of blade 20 cuts against a metal surface.

The perforations can be any slit/tie combination. Ties 36 for either face sheet 30 or liner 32 must align with some of ties 36 for the other sheet as second depression 24b results in identical ties 36 in both sheets. Preferably, blade 20 is hand sharpened. When blade 20 is hand sharpened, perforations are preferably at least 0.027 inches in tie 34 area. Because of the close tolerances needed leave ties 34 in one sheet while cutting the other, precision in the sharpening or machining the heights of projections 22 and depressions 24 is necessary.

1. A perforation over perforation die comprising:
a multilevel blade having a plurality of cutting projects separated by a plurality of depressions,
said depressions comprising a plurality of first depressions each having a first height and a cutting surface at their base and a plurality of second depressions each having a second height.

2. The perforation over perforation die of claim 1 wherein the first and second depressions are interspersed at regular intervals.

3. The perforation over perforation die of claim 1 wherein the multi-level blase is on an engraved rotary tool, a thin plate tooling applied to a magnetic cylinder or is a removable perforation blade die.
